(19) United States
(12) Patent Application Publication
(10) Pub. No.: US 2021/0284399 A1
(43) Pub. Date: Sep. 16, 2021

(54) Sealed Storage Box with Push Closure

(71) Applicant: RL RND and IP Holdings Limited, Honk Kong (HK)

(72) Inventor: Micky Peretz, Tel Aviv (IL)

(73) Assignee: RL RND AND IP HOLDINGS LIMITED

(21) Appl. No.: 16/819,306

(22) Filed: Mar. 16, 2020

(51) Int. Cl. B65D 43/26; B65D 43/02; B65D 53/02

(52) U.S. Cl. CPC B65D 43/26; B65D 2251/20; B65D 53/02; B65D 43/021

(57) ABSTRACT

A storage box that includes a container, a lid for covering and sealing the container and a circular seal that encloses the lid. The lid includes a bottom plate, a top push plate, a cam body with sloping teeth, and a spring. The bottom plate includes a base that contains the spring and the cam body. The base includes stopping members and the top push plate includes sloping pushing teeth. The spring is positioned inside the base of the bottom plate and the cam body is placed on the spring. The top push plate is assembled on the bottom plate and the cam body is connected to the top push plate in a way that enables a rotational movement and a limited relative vertical movement. The lid is designed to be in a retracted close position or in an extended open position.

### TECHNICAL FIELD

The present invention refers to a sealed storage box.

### BACKGROUND ART

It is very common to use sealed storage boxes for food storage and other materials, and the market is hungry for new and efficient boxes of this kind.

The present invention discloses a new and innovative sealed storage box.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts the storage box (10) that includes the container and the lid.

FIG. 2 depicts the storage box (10) in the extended open position.

FIG. 3 depicts the container (20).

FIG. 4 depicts a top view of the lid (30).

FIG. 5 depicts a bottom view of the lid (30).

FIG. 6 is an exploded view of the lid (30) and its parts with the circular seal.

FIG. 7 depicts the bottom plate (31).

FIG. 8 depicts the bottom plate (31) with the cam body (33).

FIGS. 9 and 10 depict the bottom view of the top push plate (32).

FIGS. 11A and 11B depict the lid in the retracted close position.

FIGS. 12A and 12B depict the lid in the extended open position.

### THE INVENTION

The main object of the present invention is to provide a storage box (10) that includes a container (20) that is designed to contain food or other materials that the user wants to store, a lid (30) that is designed to cover and seal the top opening of the container and a circular seal (40).

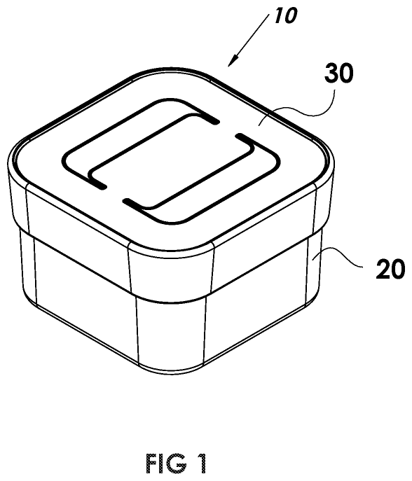

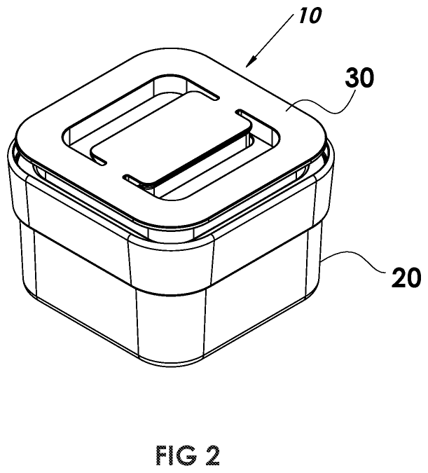

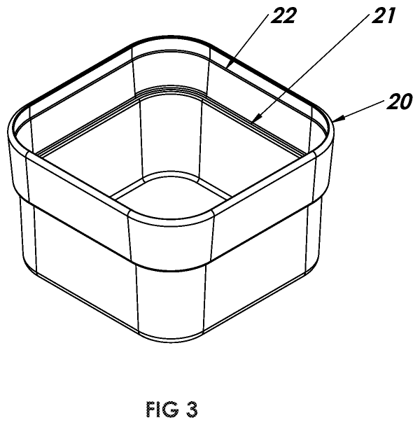

The container (20) includes a top opening (21) and an inner peripheral shoulder (22) on which the lid (30) is designed to be positioned. FIG. 1 depicts the storage box (10) that includes the container (20) and the lid (30). FIG. 2 depicts the storage box (10) in an open position. FIG. 3 depicts the container (20).

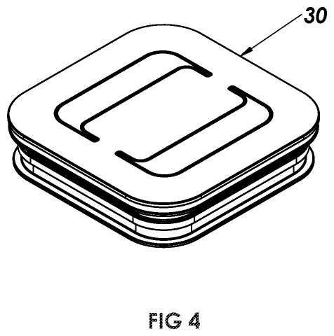

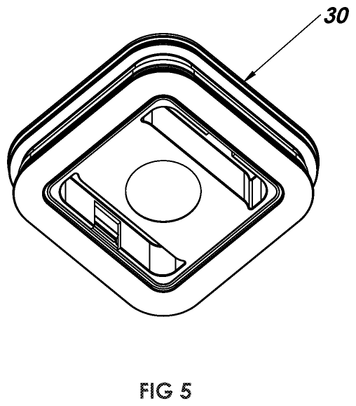

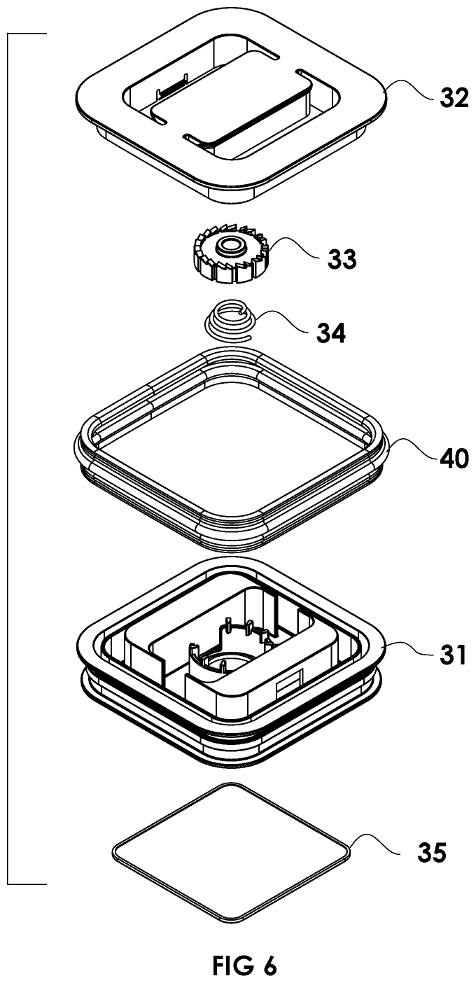

The lid (30) includes a bottom plate (31), a top push plate (32), a cam body (33), a spring (34), and may also include a bottom cover (35). FIG. 4 depicts a top view of the lid (30) and FIG. 5 depicts a bottom view of the lid (30). FIG. 6 is an exploded view of the lid (30) and its parts with the circular seal.

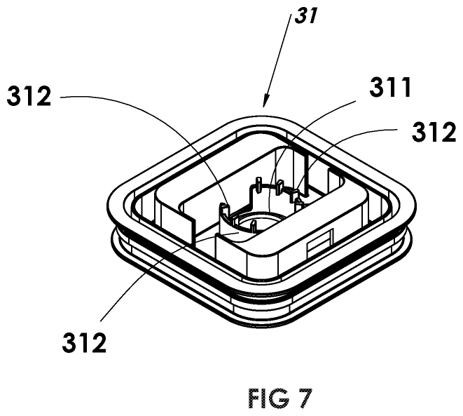

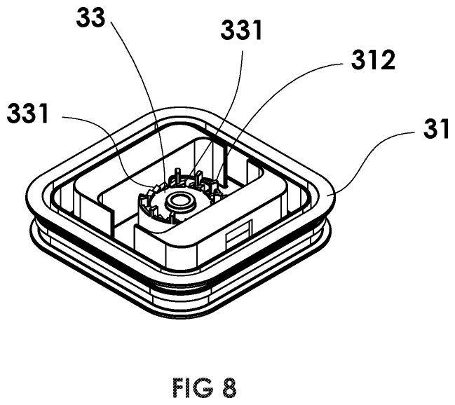

The bottom plate (31) includes a base (311) that is adapted to contain the spring (34) and the cam body (33). The base (311) includes one or more stopping members (312). FIG. 7 depicts the bottom plate (31) and FIG. 8 depicts the bottom plate (31) when the spring (not shown) and the cam body (33) are positioned in the base (311).

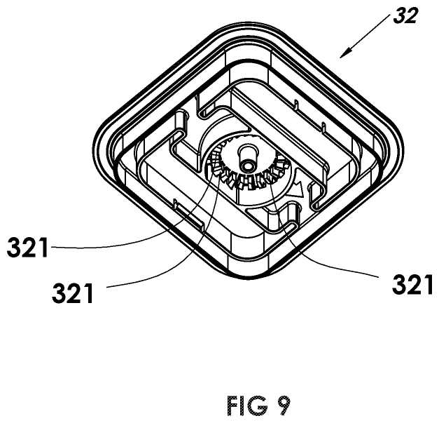

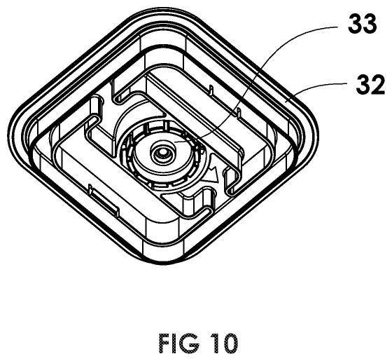

The cam body (33) includes several sloping teeth (331) and in the drawings that are attached to the present application the cam body includes 22 sloping teeth (331) but it can have more or less. The top push plate (32) includes several vertical sloping pushing teeth (321). FIG. 9 depicts a bottom view of the top push plate (32) and FIG. 10 depicts a bottom view of the top push plate (32) when the sloping teeth (331) of the cam body (33) are combined with the sloping pushing teeth (321) of the top push plate (32). In the drawings that are attached to the present application the top push plate includes 22 sloping pushing teeth (321) but it can have more or less.

The stopping members (312) of the bottom plate (31) together with the cam body (33), the spring (34) and the sloping pushing teeth (321) of the top push plate (32) serve in fact as a retract extend mechanism that works in general as the known retractable ballpoint pen mechanism. In action, the cam body (33) rotates and slides up and down, the top push plate (32) with the sloping push teeth (321) does not rotate but only slides up and down and serves as a plunger, and the bottom plate (31) with the stopping member (312) never move.

The way of assembling the parts of the lid (30) together with the circular seal (40): First, placing the spring (34) inside the base (311) of the bottom plate (31) and then placing the cam body (33) on the spring (34). Then, assembling the top push plate (32) on the bottom plate (31). The top push plate and the bottom plate may include means that enable to connect them together in a way that enables a relative movement up and down between them. After that, assembling the circular seal (40) around the lid (30). The cam body (33) is connected to the top push plate (32) in a way that enables a rotational movement between them and a slight relative vertical movement.

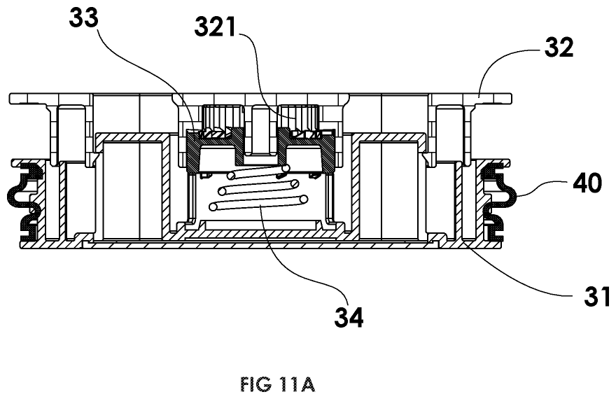

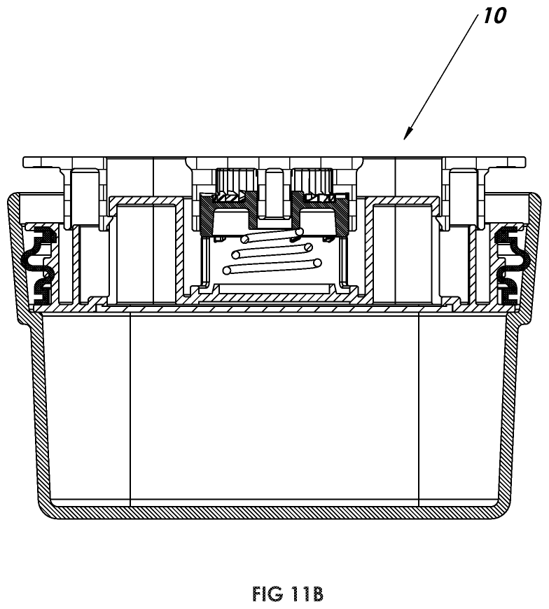

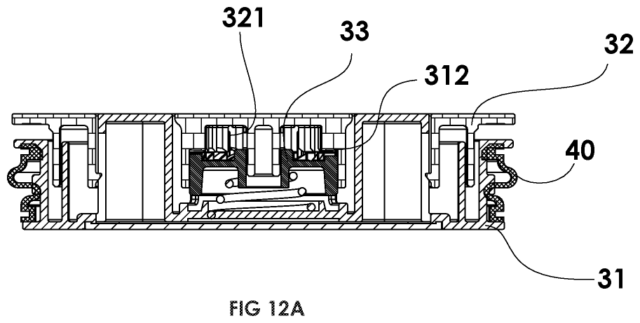

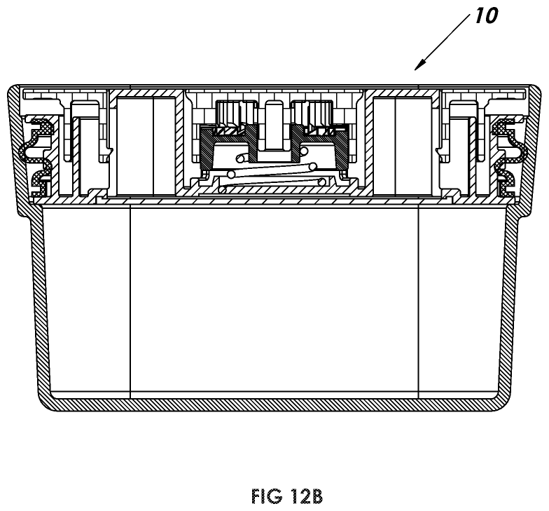

Retracted close position and extended open position of the lid (30): When the slopping teeth (331) of the cam body (33) are under the stopping members (312) of the bottom plate (31) as illustrated for example in FIGS. 11A and 11B, then the top push plate (32) is tight downward to the bottom plate (31) due to the fact that the cam body (33) is ‘locked’ under the stopping members (312), and this is the retracted close position of the lid. When the slopping teeth (331) of the cam body (33) are not under the stopping members (312) of the bottom plate (31) as illustrated for example in FIGS. 12A and 12B, then the top push plate (32) is released upward away from the bottom plate (31) due to the fact that the circular seal (40) push it up and due to the fact that the cam body (33) is no longer ‘locked’ under the stopping members (312), and this is the extended open position of the lid.

When the user pushes down the top push plate (32) these positions are changed. For example, when the lid is in the extended open position and the user pushes down the top push plate (32) then the cam body (33) push down the spring and the cam body makes one rotational step so that the now the slopping teeth (331) are now under the stopping members (312) and the lid is now come to the retracted close position, and so on.

What we claim is:

1. A storage box, comprising: a container that is designed to contain materials, a lid that is designed to cover and seal a top opening of the container and a circular seal that is designed to enclose the lid;
wherein the container includes the top opening and an inner peripheral shoulder on which the lid is designed to be positioned;
wherein the lid includes a bottom plate, a top push plate, a cam body with sloping teeth, and a spring; wherein said bottom plate includes a base that is adapted to contain the spring and the cam body; wherein said base includes stopping members; wherein the top push plate includes sloping pushing teeth;
wherein said spring is designed to be positioned inside the base of the bottom plate and the cam body is designed to be placed on the spring; wherein the top push plate is designed to be assembled on the bottom plate; wherein the cam body is designed to be connected to the top push plate in a way that enables a rotational movement between them and limited relative vertical movement; wherein the lid is designed to be in a retracted close position or in an extended open position, said positions can be changed whenever a user push down the top push plate.
